(19) United States
(12) Patent Application Publication
(10) Pub. No.: US 2026/0143202 A1
(43) Pub. Date: May 21, 2026

(54) Method and base station for the optimized transmission of audio-visual content

(71) Applicant: ORANGE, ISSY-LES-MOULINEAUX (FR)

(72) Inventors: Mathieu RIVOALEN, CHATILLON CEDEX (FR); Hervé MARCHAND, CHATILLON CEDEX (FR)

(21) Appl. No.: 19/396,461

(22) Filed: Nov. 21, 2025

(30) Foreign Application Priority Data
Nov. 21, 2024 (FR) FR2412763

(51) Int. Cl. H04N 21/61; H04N 21/239; H04N 21/442; H04N 21/6405

(52) U.S. Cl. CPC H04N 21/6131; H04N 21/2393; H04N 21/44204; H04N 21/6405

(57) ABSTRACT

A method for transmitting an audio-visual content available on a content server towards a set of communication terminals via a cellular mobile telecommunications network. The method includes: detection by a base station that at least two communication terminals served by the base station are consuming the same audio-visual content; transmission of a request for the audio-visual content by the base station to the content server; and delivery of the audio-visual content towards the at least two communication terminals.

### CROSS REFERENCE TO RELATED APPLICATION

This Application claims priority to French Patent Application No. FR2412763, filed Nov. 21, 2024, the entire contents of which are incorporated herein by reference.

### TECHNICAL FIELD

The field is that of the transmission of audio-video content from a content server to communication terminals via a cellular mobile telecommunications network.

The proposal more specifically relates to a method for such transmission as well as a base station suitable for implementing this method.

### BACKGROUND

The audio-video content is consumed more and more in mobility, from terminals such as Smartphone-type mobile phones, digital tablets or laptops connected to a cellular mobile network. Users can thus access this content anytime anywhere, whether it is streaming, downloading or on-demand (or VoD for Video on Demand). For example, many users can access audiovisual or audio-video content in public transport, but also during breaks at school, at work, at home, in public places, etc.

This evolution of the usage patterns places an increasing load on the 3G/4G/5G cellular network. Traffic peaks for some content can then pose problems for the infrastructure of this cellular network. For example, the effect of a traffic peak on a cell can saturate it and seriously impact the ability of the terminals served by the base station associated with this cell to access the cellular network.

In such a situation indeed, the base station sees the data streams relating to the requested audio-visual content transit between the content server and the set of terminals, each stream being a stream transmitted in unicast.

Such content can typically be a streaming or “live” audio-video content. For example, it could be a major football match or any other high-audience content.

Such a situation is therefore unacceptable to users, and there is therefore a need to improve the current proposals of the state of the art.

### SUMMARY

An aspect of the present disclosure aims to improve the situation of the state of the art. Particularly, there is proposed a method and a base station for transmitting an audio-visual content in an optimized manner, in particular corresponding to a traffic peak, towards consumer communication terminals.

More specifically, there is proposed a method for transmitting an audio-visual content available on a content server towards a set of communication terminals via a cellular mobile telecommunications network, comprising:
detection by a base station that at least two communication terminals served by said base station are consuming the same audio-visual content;
transmission of a request for said audio-visual content by said base station to said content server;
delivery of said audio-visual content towards said at least two communication terminals.

There is thus proposed that the base station becomes a client, or recipient, of a transmission of the audio-visual content requested from the content server, instead of the end terminals. This transfer makes it possible to considerably limit the downlink traffic towards the base stations when they are solicited by a peak of demands from the served terminals.

It is particularly interesting that the method does not provide for additional network elements and can, on the contrary, be implemented within the base stations already deployed in the field, so that a software update alone allows the implementation of the proposed method.

Furthermore, this method allows a decision at the scale of the base station: the latter can detect a situation among the connected terminals that justifies the transmission of a request for the content requested by the base station. This fine granularity allows better adaptation to traffic fluctuations in a mobile network and to handovers.

According to exemplary embodiments, an aspect of the present disclosure comprises one or more of the following characteristics which can be used separately or in partial combination with each other or in total combination with each other:
the base station determines whether said at least two communication terminals are consuming said audiovisual content in the same quality in order to transmit said request. The method can then take into account the qualities required by the terminals to share the load of the link between the content server and the base station.
the delivery towards said at least two communication terminals is a broadcasting within the cell associated with said base station. The base station can thus also reduce its own load by limiting itself to a single delivery towards all the recipient terminals, without having to manage peer-to-peer (1-1) links.
a plurality of base stations broadcast said audiovisual content on the same frequency and in time synchronization. As will be seen later, this option improves the quality of service for the terminals in mobility from one cell to another and avoids the interference, in particular at the cell edge.
the broadcasting comprises the creation of a single-frequency network.
the audiovisual content is transmitted in multicast mode from said content server to said plurality of base stations. This option provides additional gain by limiting the bandwidth for conveying the same content towards a plurality of base stations.
the base station implements a control of access to said broadcasting by said communication terminals. This option makes it possible to manage the access to the content, in particular in the cases where a broadcast could make it accessible to everyone.
the content is a content corresponding to a traffic peak, for example a streamed content. However, the method can be applied to different situations, and not necessarily for content corresponding to traffic peaks.

Another aspect of the disclosure relates to a computer program including instructions for implementing a method as previously described when executed by a processor.

Another aspect relates to a base station for transmitting an audio-visual content available on a content server towards a set of communication terminals via a cellular mobile telecommunications network, comprising a processor configured to:
detect that at least two communication terminals served by said base station are consuming the same audio-visual content;
transmit a request for said audio-visual content to said content server;
deliver said audio-visual content towards said at least two communication terminals.

Another aspect relates to a communications network including at least one base station as previously described. According to embodiments, several base stations may belong to the same multicast delivery tree of the audiovisual content.

Another aspect relates to a computer program able to be implemented on a base station, the program comprising code instructions which, when these instructions are executed by a processor, cause the latter to implement at least some of the steps of the method previously described.

Another aspect relates to a data medium on which at least one series of program code instructions has been stored for the execution of at least some of the steps of a method as previously defined.

### BRIEF DESCRIPTION OF THE DRAWINGS

Other aspects, aims, advantages and characteristics of the disclosure will appear better upon reading the following detailed description of illustrative embodiments thereof, given by way of non-limiting example, and made with reference to the appended drawings in which:

FIG. 1 illustrates a simplified example of a content delivery network;

FIG. 2 illustrates a simplified example of an audiovisual content delivery network, according to one embodiment;

FIG. 3 illustrates a simplified example of a delivery network including two base stations, according to one embodiment.

### DETAILED DISCLOSURE OF PARTICULAR EMBODIMENTS

The method described can be applied to various cellular mobile telecommunications network technologies.

This type of network aims to allow communication terminals in mobility to access data networks by allowing them to dynamically connect to base stations distributed across a territory using a radiocommunication protocol. Each base station is associated with a cell forming a sub-part of this territory covered by one (or more) relay antennas. The base stations are also connected to each other by a network called backhaul, generally using optical fibers or other high-speed wired links.

A mobile telecommunications network constitutes an access network to the various interconnected data networks throughout the world, commonly and collectively referred to as the Internet.

These cellular mobile telecommunications networks are standardized by organizations such as the ITU (International Telecommunication Union) and the 3GPP (3rd Generation Partnership Project) and are designated according to the 3G, 4G, 5G, etc. generation.

Most communication terminals are compatible with the different generations of mobile telecommunications standards. These terminals can be mobile phones (most often Smartphones), digital tablets, but also computers (in particular laptops), connected objects, etc. Within the framework of the described proposal, the communication terminal can be characterized solely by its ability to connect to a cell of a mobile network and receive an audio-visual content.

The audio-visual content can be understood in the broadest sense, that is to say comprising the video content including at least one audio track, but also video content without an audio part, or the purely audio content. As illustrative examples, this audiovisual content may comprise the television programs, films, deliveries of sporting events or, more generally, entertainment events, etc.

The content is generally available from content servers, responsible for delivering it within a content delivery network (CDN) which forms, in a way, an overlay of the underlying telecommunications network, including the cellular mobile phone network ensuring the downlink towards the telecommunications terminals.

Within a CDN network, a content server can make the same content available in different qualities.

Generally and currently, the common qualities comprise:
Very Low Quality: often suitable for users with very slow or unstable internet connections, this quality can have a resolution of 240 p and a bitrate of 200 kbps.
Low Quality: this quality is suitable for more stable but still relatively slow internet connections, with a resolution of 360 p and a bitrate of 400-700 kbps.
Standard Quality: this quality is suitable for most internet connections, with a resolution of 480 p or 720 p and a bitrate of 800 kbps to 2 Mbps.
High Quality: this quality is suitable for the fast and reliable internet connections, with a resolution of 1,080 p and a bitrate of 2-5 Mbps.
Very High Quality: this quality is suitable for the very fast internet connections, with a resolution of 4K and a bitrate of over 10 Mbps.

In general, the public content server contains a manifest file listing the different qualities available.

This same file indicates an element for dividing the content into downloadable segments or chunks. Thus, the communication terminal can, on the fly, send requests to the content server to retrieve the desired segment, in the desired quality, which may change over time, in particular due to transmission conditions and/or to the load of the terminal.

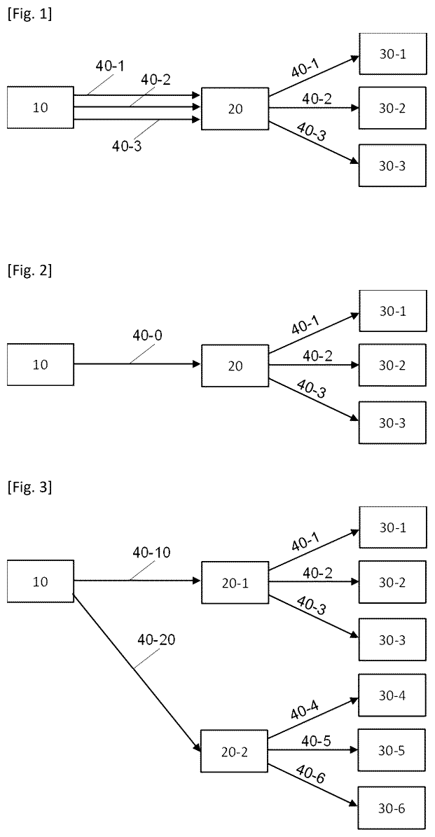

FIG. 1 illustrates a simplified example of such a content delivery network.

Three terminals 30-1, 30-2, 30-3 have requested the same content from the same content server 10. The latter therefore transmits three streams of segments relating to this content, respectively 40-1, 40-2, 40-3, to the terminals. It is also assumed that these streams correspond to the same quality for all three terminals.

These segment streams transit towards the base station 20, which is in particular responsible for the passage from the wired world (content server/base station link) to the radio world (base station/terminal link). Within the framework of a 3G/4G/5G network, the base station 20 can also be called BTS (Base Transceiver Station), NodeB, or gNodeB. Hereinafter, the term “base station” will be adopted to cover these different types of equipment and functions, which may vary according to standards and normative documents.

It appears in this example that the upstream network, linking the content server 10 to the base station 20, is loaded by the transmission of the streams 40-1, 40-2, 40-3, while these are identical since, in the example, they correspond to the same content in the same quality.

It is understood that when the number of terminals receiving the same content in the same quality is significant, the stream of identical content segments is duplicated, generating an overload of the telecommunications network and of the base station. In case of traffic peak, network infrastructure saturation impacting the quality of service for users may then occur. In extreme cases, some users may even lose access to the mobile telecommunications network.

According to the state of the art, traffic related to the transmission of audiovisual content is not analyzed by the base station since the content delivery network (CDN) forms an overlay to the transport network.

The proposed method aims to detect such a situation and remedy it. More specifically, it aims to take advantage of the capacities of the base stations to avoid their congestion and the saturation of the downlink towards them. It is proposed to involve the base stations in the management of the transmission of the audiovisual content from the content server to the terminals; In other words, base stations become elements of the content delivery network CDN.

Particularly, the base stations can be considered as incorporating nanoCDN functionalities.

Generally, a base station comprises at least one radio communication interface, and antennas enabling the communication towards the communication terminals, an interface towards the backbone wired network enabling interconnection of the base stations with other communication elements and in particular content servers 10, and processing means including one or more processors, memories and specialized circuits.

FIG. 2 illustrates a simplified example of an audio-visual content delivery network according to a proposed embodiment, including a content server 10, a base station 20 and three communication terminals 30-1, 30-2, 30-3 served by this base station, that is to say covered by the cell associated with this base station.

The concerned audiovisual content may correspond to a traffic peak, but the proposed method can be implemented for audiovisual content meeting different criteria, and even for any audiovisual content.

The base station 20 is adapted to detect that at least two communication terminals (served by itself) are consuming the same audiovisual content.

According to one embodiment, the base station determines whether these at least two communication terminals are consuming this audiovisual content in the same quality. Indeed, as seen previously, the same audiovisual content may be available in different qualities, which allows adaptation to the transmission and production conditions by the communication terminals playing this content.

If it is detected that at least two terminals are consuming, that is to say receiving, the same audiovisual content and, according to one embodiment, in the same quality, then the base station 20 can trigger a specific processing.

This particular processing comprises, for the base station, switching to an operation where it acts as a nanoCND for the communication terminals in question, and as a client for the content server 10.

To do so, the base station 20 transmits a request for the audio-visual content to the content server. In this way, the base station becomes a client of the content server. The request may also contain the desired quality.

If there are several groups of more than 2 communication terminals for the same audio-visual content but each with a different quality, then the base station 20 can transmit a request to the content server for each of these qualities.

Thus, the content server 10 transmits the audio-visual content 40-0 to the base station 20 (in the quality requested by the latter).

The base station 20 can then deliver this audio-visual content towards the communication terminal(s) 30-1, 30-2, 30-3 having previously required this audio-visual content, where appropriate in this same resolution.

Thus, by acting as a nanoCDN type “intermediate point”, the transmissions of the segment streams corresponding to this audio-visual content are shared on the content server link 10 towards the base station: FIG. 2 shows a single transmission 40-0, while FIG. 1 represents three transmissions 40-1, 40-2, 40-3.

This results in significant savings in the bandwidth and the resources of the communication network and the base station: even a significant traffic peak on this audio-visual content can have only a very limited impact due to this sharing, which makes it possible to avoid, or at least limit, the situations of cell congestion and saturation.

The link between the base station 20 and the communication terminals is local. FIG. 2 represents three transmissions 40-1, 40-2, 40-3 towards respectively the three communication terminals 30-1, 30-2, 30-3. This delivery can be implemented in different ways.

In particular, this delivery can be provided to avoid congestion and saturation of the cell in the radio plan.

According to one embodiment, the delivery towards the communication terminals is a broadcasting within the cell associated with the base station 20. This type of delivery does not target one particular communication terminal but is theoretically accessible to any terminal in the cell associated with the base station 20. In other words, a single emission by the base station makes it possible to reach a large number (theoretically an infinity) of communication terminals.

This embodiment therefore makes it possible to greatly relieve the load for the base station 20 and makes it possible to avoid saturation of the radio cell.

According to one embodiment, an access control may be set up by the base station in order to restrict access to the content broadcast to the concerned communication terminals. The concerned communication terminals may be those that were already consuming this audiovisual content (it is then assumed that any access control was previously performed by the content server 10).

This access control may be based on the identifier of the communication terminal (IMEI/IMSI identifier). The IMEI (International Mobile Equipment Identity) is a unique number assigned to each mobile device (phone, tablet, etc.) that allows it to be uniquely identified on a mobile network. The IMSI (International Mobile Subscriber Identity) is a unique identifier associated with a mobile subscriber (user). It is stored in the SIM card of the user and allows the subscriber to be identified on the mobile network.

The access control can also be based on rights management, for example of the DRM (Digital Rights Management) type. Data on the access rights, of the DRM type, can be associated with the broadcast content, so that only the terminals that satisfy the access rights can effectively decode the data streams they receive in broadcast.

In the case where the same audiovisual content is consumed by several groups of terminals, each with a distinct quality, the content can be required according to these different qualities from the content server by the base station. The latter can then deliver this content according to these different qualities within the cell. According to one embodiment, therefore, the base station performs broadcasting by required quality of the audiovisual content.

A traffic peak on an audiovisual content very generally impacts not a base station but a territory. In other words, it may be intended to implement the method just described on a set of base stations in a given territory, or even for all the base stations.

But it may also be intended to manage the interactions between these base stations in order to optimize the transmission of the audio-visual content towards the communication terminals, in particular by taking into account the fact that these are mobile and can therefore move from one cell to another during the audio-visual content delivery.

Thus, a plurality of base stations could deliver the same audiovisual content. In the case of a broadcast, this content could be on the same frequency and in time synchronization.

To do so, according to one embodiment, the broadcasting comprises a prior creation of a single-frequency network.

Such a single frequency network, or SFN, is a transmission mechanism provided as part of the broadcasting service of the 5G telecommunications standards, FeMBMS (Further evolved Multimedia Broadcast Service).

According to this mechanism, the same data are emitted by multiple antennas (that is to say base stations) on the same frequency. The data is also time-synchronized, so that the radio signals overlap and do not create interference. Thus, the overall quality of the transmissions is improved, in particular as part of the management of the handovers from one cell to another of a communications terminal: at the cell edge, it receives the broadcasts from the (at least) two base stations of the neighboring cells, whose powers are added together. The handover to the neighboring cell therefore causes no interruption of service.

The synchronization of the signals corresponding to these broadcasts can be provided by the base stations which are naturally synchronized with each other via the telecommunications network.

FIG. 3 illustrates such a situation where two base stations 20-1, 20-2 receive the same audio-visual content from a content server 10. This content is transmitted by two segment streams 40-10, 40-20, to the base stations 20-1, 20-2 respectively.

Each of these base stations can then deliver the content to the communication terminals served, that is to say 30-1, 30-2, 30-3 for the base station 20-1 and 30-4, 30-5, 30-6 for the base station 20-2.

According to one embodiment, the audio-visual content is transmitted in multicast mode from the content server towards the plurality of base stations 20-1, 20-2.

The multicast in 5G is a data transmission technology that allows sending information simultaneously to several users or connected devices, by using a single transmission instead of sending data individually to each recipient.

The data are transmitted from a content server to a set of base stations that form receiver nodes through a hierarchical structure called delivery tree. Each base station can connect to a node in the delivery tree so as to optimize the distribution (that is to say minimize the redundancy of the transmissions within the telecommunications network).

The advantages of the multicast and those of the method described are thus combined by positioning base stations as leaves of the delivery tree. These two elements therefore make it possible to further improve the performance in terms of resource savings by leveraging their synergy.

The mechanism described therefore proposes an innovative method for transmitting a content, in particular a highly requested audiovisual content, from a content server to terminals via a cellular mobile radiocommunication network. It is based in particular on the fact that the base stations can act as nanoCDNs when they detect that several terminals have subscribed to the same content, and where appropriate in the same quality. These base stations can then broadcast this content locally, which allows further relieving the base stations and not saturating the cell. This mechanism thus makes it possible to cope with the content delivery having a massive audience, such as international football matches, including for cells that are already considerably loaded.

Of course, the present invention is not limited to the examples and the embodiment described and represented, but is defined by the claims. It is in particular subject to numerous variants accessible to those skilled in the art.

1. A method for transmitting an audio-visual content available on a content server towards a set of communication terminals via a cellular mobile telecommunications network, the method comprising:
detecting by a base station that at least two communication terminals served by said base station are consuming a same audio-visual content;
transmitting a request for said audio-visual content by said base station to said content server; and
delivering said audio-visual content towards said at least two communication terminals.

2. The method according to claim 1, comprising said base station determining whether said at least two communication terminals are consuming said audiovisual content in a same quality in order to transmit said request.

3. The method according to claim 1, wherein said delivering towards said at least two communication terminals comprises broadcasting within a cell associated with said base station.

4. The method according to claim 3, comprising a plurality of base stations broadcasting said audiovisual content on a same frequency and in time synchronization.

5. The method according to claim 4, wherein the broadcasting comprises creating a single-frequency network.

6. The method according to claim 4, wherein said audiovisual content is transmitted in multicast mode from said content server to said plurality of base stations.

7. The method according to claim 3, comprising said base station implementing a control of access to said broadcasting by said communication terminals.

8. The method according to claim 1, wherein said content is a content corresponding to a traffic peak.

9. A non-transitory computer readable storage medium comprising code instructions stored thereon which, when executed by at least one processor of the base station, cause the base station to implement the method defined in claim 1.

10. A base station comprising:
at least one processor configured to transmit an audio-visual content available on a content server towards a set of communication terminals via a cellular mobile telecommunications network, by:
detecting that at least two communication terminals served by said base station are consuming a same audio-visual content;
transmitting a request for said audio-visual content to said content server; and
delivering said audio-visual content to said at least two communication terminals.
